(19) United States
(12) Patent Application Publication
(10) Pub. No.: US 2016/0339791 A1
(43) Pub. Date: Nov. 24, 2016

(54) AUTONOMOUS CHARGING FOR ELECTRIC VEHICLES

(71) Applicant: Lawrence Yong Hock Sim, Port Coquitlam (CA)

(72) Inventor: Lawrence Yong Hock Sim, Port Coquitlam (CA)

(21) Appl. No.: 15/161,195

(22) Filed: May 21, 2016

Related U.S. Application Data
(60) Provisional application No. 62/164,370, filed on May 20, 2015.

(51) Int. Cl. B60L 11/18; G06Q 20/32; H02J 7/00; G06Q 50/06; B25J 9/02; B25J 9/16

(52) U.S. Cl. CPC B60L 11/1835; B60L 11/1816; B60L 11/1848; B25J 9/02; B25J 9/1669; H02J 7/0027; G06Q 50/06; G06Q 20/3278; B60L 2230/10

(57) ABSTRACT

Methods and systems for coupling a chargeable battery in an electric vehicle with a charging station are disclosed. One such system includes an arm mountable on the vehicle, an actuator coupled to the arm and configured to move the arm, and a charger coupled to the arm and electrically couplable to the vehicle's electrical system. A processor is communicatively coupled to the actuator and configured to control the actuator. The processor is also communicatively coupled to a readable memory. The readable memory has stored thereon instructions executable by the processor for controlling the actuator to move the charger to electrically couple with the charging station.

### TECHNICAL FIELD

The present disclosure is directed to systems and methods for charging electric vehicles. More particularly, the present disclosure is directed to systems and methods for autonomous charging of electric vehicles.

### BACKGROUND

With the growing awareness and concern of the impact of carbon emissions from vehicles, as well as the volatility of oil prices, electric and hybrid vehicles are becoming increasingly popular. The rapid advancement of battery storage technology has made electric and hybrid vehicles a viable option for many people.

Electric vehicles generally use a large storage battery that needs to be recharged periodically. The range for a typical electric car may be 60-150 km on a single charge. Due to the lack of charging stations in some locations, drivers of electric vehicles tend to charge their vehicles daily to ensure they are not caught in a situation where they have insufficient charge to reach their destination. Fully charging an electric vehicle may take several hours.

Electric vehicles can be charged at a charging station, which is also referred to as an electric vehicle supply equipment (“EVSE”). These may be found in various locations, such as parking garages. Many people charge their electric vehicles at home.

There exists a continuing desire to advance and improve technology related to charging electric vehicles.

### SUMMARY

In accordance with an illustrative embodiment of the disclosure, there is provided a charging system for coupling a chargeable battery in an electric vehicle with a charging station. The system includes an arm mountable on the vehicle, an actuator coupled to the arm and configured to move the arm, a charger coupled to the arm and electrically couplable to the vehicle's electrical system, a processor communicatively coupled to the actuator and configured to control the actuator, and a readable memory communicatively coupled to the processor and having stored thereon instructions executable by the processor for controlling the actuator to move the charger to electrically couple with the charging station.

The arm may also include multiple members connected in series by flexible joints.

The arm may be mountable on top of the electric vehicle.

The instructions may also include instructions for using coordinate mapping to guide the charger to couple with the charging station.

The instructions may further include instructions for synchronizing mapping coordinates with the charging station.

The system may also include a wireless communications port communicatively coupled to the processor for wirelessly communicating with the charging station.

The charger may be raisable by the arm for engaging with an overhead charging board of the charging station.

The system may also include a camera attached to the arm and communicatively coupled to the processor for optically guiding the charger to couple with the charging station.

The executable instructions may also include instructions for uncoupling the charger from the charging station and returning it to the vehicle upon receipt of a cease charging signal.

The system may also include a manual control hub communicatively coupled to the processor for inputting commands to move the arm.

The system may also include instructions stored on the readable memory for execution by the processor for wirelessly sending payment information to the charging station to pay for charging.

In accordance with another illustrative embodiment of the disclosure, there is provided a system for charging an electric vehicle. The system includes an overhead charging board comprising conductors. The overhead charging board is couplable to a charging station. The system also includes an arm mountable on the vehicle, an actuator coupled to the arm and configured to move the arm, a charger coupled to the arm and electrically couplable to the vehicle's electrical system, a processor communicatively coupled to the actuator and configured to control the actuator, and a readable memory communicatively coupled to the processor and having stored thereon instructions executable by the processor for controlling the actuator to move the charger to electrically couple with the overhead charging board.

In accordance with another illustrative embodiment of the disclosure, there is provided an overhead charging port for coupling a charging station to an electric vehicle. The charging port includes a panel with a planar surface, a ridge extending from the planar surface, an electrical conductor attached to a surface of the ridge and configured to couple with a charger from the electric vehicle, where the electrical conductor is electrically coupled to the charging station, and an attachment apparatus connected to the panel and configured to couple with a suspending apparatus for suspending the panel above a driving surface such that the planar surface faces the driving surface.

The ridge may run along an edge of the planar surface.

The ridge may run along a length of the planar surface between the edges of the planar surface.

The electrical conductor may run in a track along a side of the ridge.

In accordance with another illustrative embodiment of the disclosure, there is provided a method for electrically coupling an electric or hybrid vehicle to a charging station. The method includes actuating an arm mounted on the vehicle, wherein the arm comprises a charger electrically coupled to the vehicle's electrical system and wherein the arm is coupled to an actuator, and guiding the charger to electrically couple with the charging station.

Coordinate mapping may be used to guide the charger to couple with the charging station.

The method may also include synchronizing mapping coordinates between the arm and the charging station.

The method may also include wirelessly communicating with the charging station using a wireless communications port.

Guiding the charger may also include raising the charger with the arm to engage the charger with an overhead charging board of the charging station.

The method may also include optically guiding the charger to couple with the charging station using a camera attached to the arm.

The method may also include uncoupling the charger from the charging station and returning it to the vehicle upon receipt of a cease charging signal.

The arm may be guided using commands manually input into a manual control hub to control the actuator.

The method may also include wirelessly sending electronic data comprising payment information to the charging station to pay for charging.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments,

FIG. 1 is a block diagram of an automatic charging system;

FIGS. 2A, 2B, and 2C show different charging positions using an automated charging system according to some embodiments;

FIG. 3 shows the automatic charging system of FIG. 1 stowed on a roof of a vehicle;

FIG. 4 is a view of a charger attached to a robotic arm approaching a charging port;

FIG. 5 is a partial sectional view of the charging port and the charger of FIG. 4;

FIG. 6A is a view of a charger with recessed induction probes approaching a charging port;

FIG. 6B is a view of the charger of FIG. 6A with the probes extended and in contact with the charging port;

FIG. 7A is a view of a charger containing recessed induction probes;

FIG. 7B is a view of the charger of FIG. 7A with the induction probes extended;

FIG. 8 is a is side view of a charger approaching a charging track according to various embodiments;

FIG. 9 is a graphical representation of a mapping method according to certain embodiments;

FIG. 10 shows an electric vehicle charging at a street lamp post using an automated charging system;

FIG. 11 shows a manual overwrite control panel according to various embodiments;

FIG. 12 shows a block diagram of a method for charging an electric vehicle using an automatic charging system; and

FIGS. 13A and 13B are perspective views of overhead charging boards.

### DETAILED DESCRIPTION

Directional terms such as “top”, “bottom”, “upper”, “lower”, “left”, “right”, and “vertical” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, and “coupling” as used in this description are intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections.

As with other battery-operated products, an electric vehicle likewise has to be regularly charged in order to operate. Unlike gasoline powered vehicles that may be driven for several days on a single tank of gasoline, electric vehicles may be charged almost on a daily basis for routine driving.

One reason electric vehicles may be charged daily is due to “range anxiety”. Range anxiety is the phobic fear of running out of power, especially when driving along unfamiliar routes and where the driver is unaware of the location of charging stations. Longer-range electric cars are available at much higher cost, but even with that, owners still may charge their cars regularly for psychological comfort because it may take hours to fully charge an electric vehicle as compared to several minutes to fill up a gasoline powered car.

Electric cars are generally charged by manually connecting a cable linking the electric vehicle charging station, generally referred to as electric vehicle supply equipment (“EVSE”), to the car's charging port. To do this regularly may be seen as a hassle by some people. However, due to long charging times, drivers are generally diligent in charging their vehicles as a quick trip to a gas station is not an option.

In the present disclosure, a robotic arm charging system that is mountable on an electric or hybrid vehicle is provided. The charging system may be factory fitted or may be an after-market kit mountable on the roof of the vehicle. The charging system may be automatically extendable in order to self-engage with an overhead charging port. The charging system may also automatically disengage and re-stow once charging is complete. The robotic arm, which includes a charger, may allow charging for cars parked in various positions.

To use the charging system, electric car drivers drive up to their home EVSE station or to a public charging kiosk. Once activated, the charger on the on-board robotic arm will engage with the EVSE station, and disengage when charging is complete.

Unlike methods used in the prior art, the system and methods of the present disclosure have the charger move to the EVSE rather than having a charging port move from the EVSE to the vehicle. Moving from the vehicle to the EVSE may reduce the chance of physical damage to the car during the coupling process.

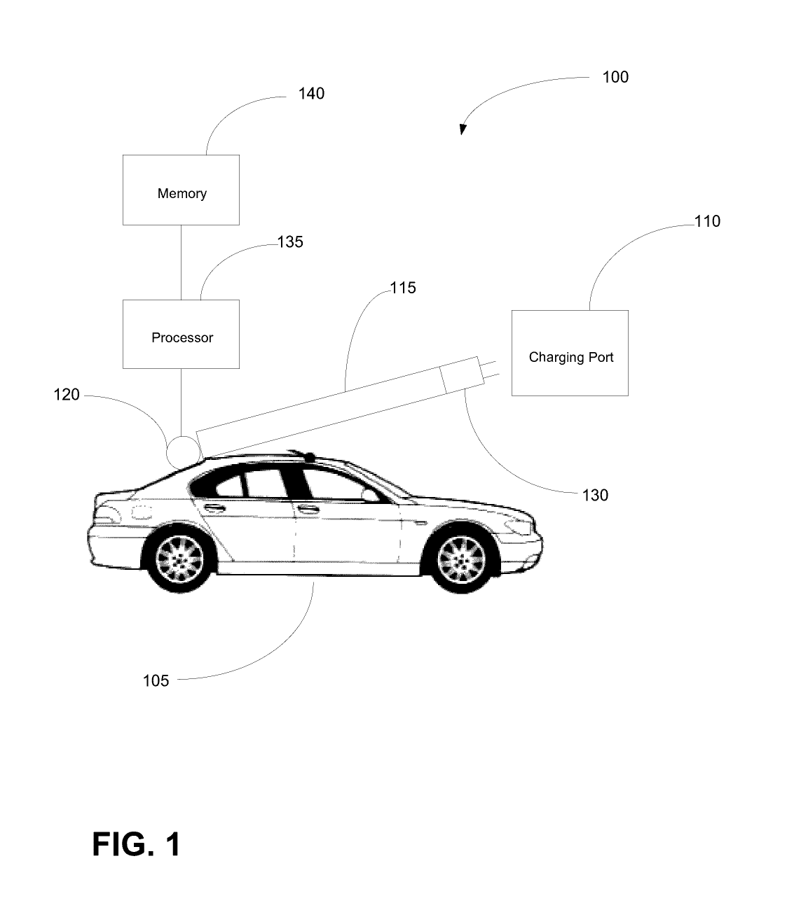

Referring to FIG. 1, an embodiment of a charging system 100 for coupling an electric vehicle 105 with a charging station 110, such as an EVSE, is shown. The charging system 100 includes an arm 115 mountable on the vehicle 105, an actuator 120 coupled to the arm 115 and configured to move the arm 115, and a charger 130 attached to the arm 115 and electrically couplable to the vehicle's electrical system. The system also includes a processor 135 communicatively coupled to the actuator 120 and configured to control the actuator 120 and a readable memory 140 communicatively coupled to the processor 135. The readable memory 140 has stored on it instructions executable by the processor 135 for guiding the charger 130 to electrically couple with the charging station 110.

In certain embodiments, the arm is a flexible electro-mechanical apparatus controlled by onboard system software. It may comprise a rotational base actuator with the ability to swing the arm 360 degrees. It may also include other pivot motors to provide vertical, horizontal, and rotary movement. The arm has an overall length that is suitable for the charger to couple with a charging port of an EVSE. An overhead charging port may be positioned at a standard height. For example, an overhead charging port may be positioned 2-4 feet higher than the average passenger car. In some cases, they may be higher or lower than this and may be adjustable to accommodate different sized cars.

In some embodiments, the arm may be formed of multiple members connected in series by flexible joints. Each flexible joint, including the base joint closest to the vehicle, may have at least one degree of freedom. In some embodiments, each flexible joint may have up to six degrees of freedom, including rotation around each of the x, y, and z axes and translation along each of the x, y, and z axes, where the origin for the axes is at the joint.

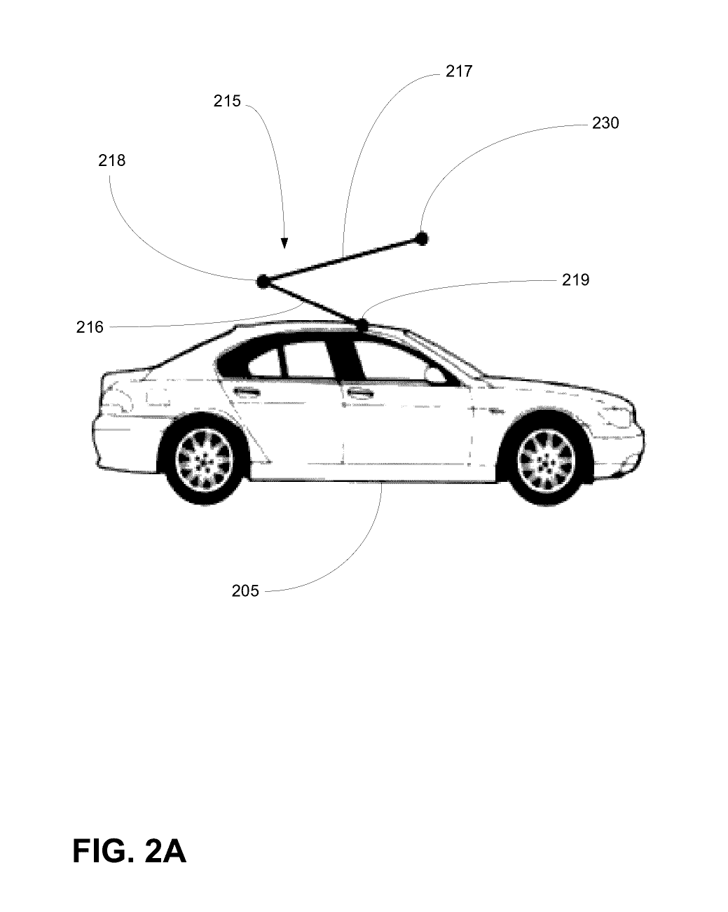

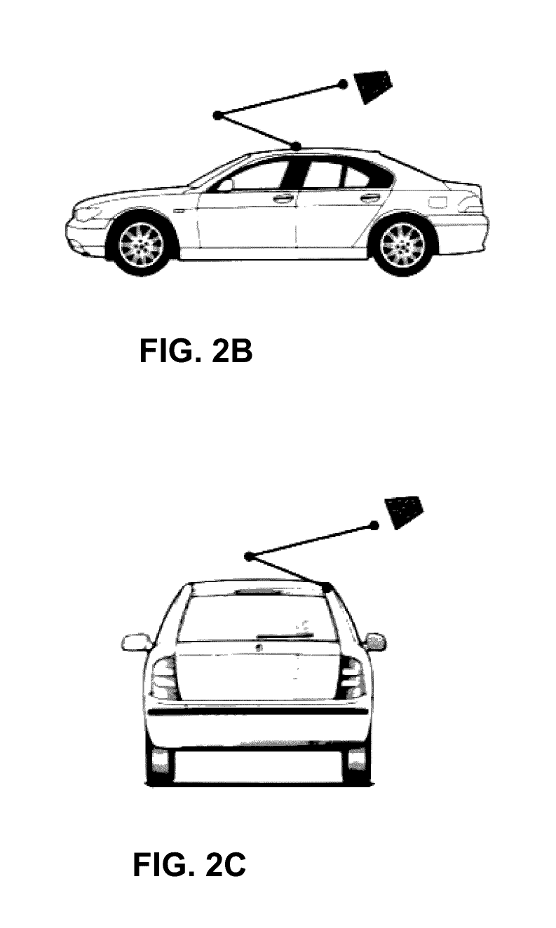

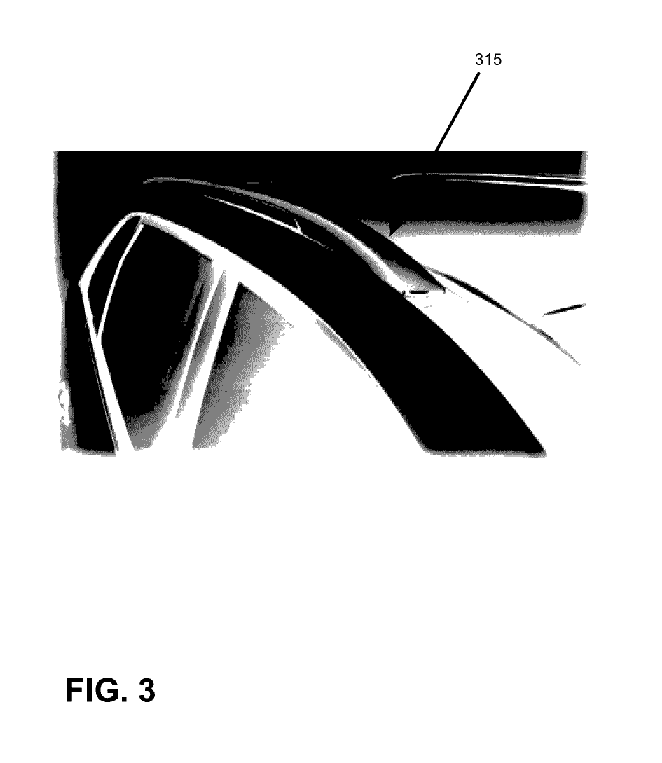

Referring to FIG. 2A, a robotic arm 215 is shown mounted on a vehicle 205. The arm 215 includes two members, a lower member 216 and an upper member 217. An upper flexible joint 218 joins the two members 216, 217 and a lower flexible joint 219 couples the lower member 216 to the vehicle 205. The lower flexible joint 219 in this embodiment has two rotational degrees of freedom: rotation around the z axis, allowing the lower member 216 to spin in position, and rotation around a lateral axis, such as the y axis, allowing the lower member 216 to pivot around the y axis so that the robotic arm may be raised or lowered in a pivoting motion. The upper flexible joint 218 has one rotational degree of freedom, allowing the upper member 217 to rotate around the y axis. Rotation around the y axis lets the upper member 217 be raised or lowered relative to the lower member 216. This configuration, with the lower flexible joint 219 providing the lower member 216 with two rotational degrees of freedom relative to the vehicle 205 and the upper flexible joint 218 providing the upper member 217 with a single rotational degree of freedom relative to the lower member 216, may provide the robotic arm 215 with a sufficient range of motion to move the charger 230 to a range of positions within reach of the robotic arm 215.

In certain embodiments, the arm may include a single member pivotally connected to a mount attached to the vehicle. The arm may be pivotally raised so that the charger at the end of the arm couples with a charging station above the vehicle, such as a charging board. In some embodiments, the joints may also provide translational movement of the member. For example, a translational degree of freedom at the joint between a lower member and a base mounted to the vehicle may allow the end of the member closest to the vehicle to move laterally relative to the mounting surface of the vehicle.

In some embodiments, the arm may comprise telescopic members that extend out telescopically. The telescopic members may be combined with non-telescopic members through, for example, flexible joints.

A member of the arm may have any suitable cross-sectional shape. In some embodiments, the member may have a circular, ellipsoidal, or rectangular cross-section. The member may be hollow or solid. For hollow members, the thickness of the wall may vary along the length of the member. In certain embodiments, the member may have, for example, an I-beam or T-beam cross-section.

A member of the arm may be made of any suitable material. For example, the member may be made of metals like aluminium alloys and steel, polymers, or composites like carbon fiber composites and fiber-glass.

Movement of the member at a joint is caused by an actuator. In some embodiments, the actuators is positioned at the joint to directly drive the member. In certain embodiments, the actuator may be positioned away from the joint and coupled to the member being driven at the joint through a drive mechanism including, for example, pulleys, belts, or chains. Alternatively, any suitable drive mechanism may be used to couple the actuators to the members being driven.

Referring to FIG. 2A, actuators for controlling motion of the lower member 216 may be positioned at the lower flexible joint 219 between the lower member 216 and the base of the robotic arm. An actuator for controlling motion of the upper member 217 relative to the lower member 216 may be positioned at the upper flexible joint 218 and coupled directly to the upper member 217. In some embodiments, the actuator may not be directly coupled to the member it is driving. The actuator may be positioned, for example, adjacent to the member, at the joint, but may be coupled to the driven member through a drive assembly, such as gears. In certain embodiments, all of the actuators are positioned at the base and coupled to the members they are driving through a suitable drive mechanism. In some embodiments, an actuator for driving a lower member may directly engage the lower member at the lower joint while an actuator for driving an upper member at an upper joint of the arm may also be located at a base position and drive the member through a drive mechanism that couples the actuator to the upper member for driving the upper member at the upper joint.

In some embodiments, a single actuator may be used for movement of a member for each degree of freedom. For example, referring to FIG. 2A, a first actuator may be used for rotation of the lower member 216 around a vertical axis and a second actuator may be used for rotation of the lower member 216 around a horizontal axis. A third actuator may be used to rotate the upper member 217 around a horizontal axis at the upper flexible joint 218.

In certain embodiments, a single actuator may be used for multiple degrees of freedom. For example, a single actuator may be used for rotation of a member around both a vertical axis and a horizontal axis at a flexible joint. Any suitable drive mechanism may be used to control multiple degrees of freedom for the member using a single actuator.

In some embodiments, an actuator is powered by the vehicle's battery. The actuator may be coupled to the vehicle's electric system and draw power from the vehicle's battery. In certain embodiments, the actuator may draw power from storage batteries specifically designated for powering the arm's systems, including, for example, the actuator and a computer. These batteries may be charged using the EVSE when the vehicle is charged. Alternatively, the actuator's batteries may be charged by the vehicle's battery or a combination of the EVSE and the vehicle battery. In certain embodiments, batteries designated for powering the arm's systems may be used as a backup system and the vehicle's battery may be the primary power source for the arm. Alternatively, any suitable power source, such as, for example, solar cells, may be used to power the arm.

Referring again to FIG. 2A, the robotic arm 215 is mounted to the top of the vehicle 205. The robotic arm 215 may be mounted on one side of the roof of the vehicle 205. Alternatively, in some embodiments, the robotic arm 215 may be mounted at any suitable position on the roof of the vehicle 205. In certain embodiments, not shown, the robotic arm may be mounted on a side of the vehicle.

Referring to FIGS. 2A, 2B, and 2C, mounting the robotic arm 215 on the roof of the vehicle 205 may allow the arm to access an EVSE on different sides of the vehicle 205. The driver may not need to park the car in a particular position in order to access the EVSE and access to an overhead EVSE may still be available even if another vehicle is parked next to the vehicle 205. For example, FIG. 2A shows the charger 230 along its path to couple with a charging port of an overhead EVSE that is level or slightly in front of the driving seat of the vehicle 205. FIG. 2B shows the charger 230 on a path to couple with a charging port of an overhead EVSE that is slightly behind the driving seat of the vehicle 205. FIG. 2C shows the charger 230 on a path to couple with a charging port of an overhead EVSE that is slightly to one side of the vehicle 205. Similarly, the charger 230 may couple with an overhead EVSE that is on the other side of the vehicle 205 (not shown).

Referring to FIG. 3, the arm 315 may be kept in a stowed position when it's not in use. The arm 315 may be stowed in a folded position, if it comprises multiple members. In some embodiments, the arm 315 may be stowed in a fully extended position. The arm 315 may be covered when it is stowed. Alternatively, the arm 315 may be stowed in an exposed position. In some embodiments, the arm 315 may be stowed within a recess of the car, such as a storage bay, with only a portion of the arm 315 extending above a surface of the roof. In certain embodiments, the arm 315 may be stowed completely below the surface of the roof. In these embodiments, the arm 315 is mounted within the recess. A cover may be used to cover the recess when the arm is stowed. In some embodiments, the cover automatically opens when the arm is to be extended and automatically closes when the arm is stowed. In certain embodiments, there may be no cover for the recess. Alternatively, any suitable type of cover may be used to cover the stowed arm.

In certain embodiments, the arm is mounted to the surface of the roof of the vehicle and not within a recess. When in a stowed position, the arm, in these embodiments, may remain above the surface of the roof. A cover may be used to cover the arm in the stowed position. The cover may be, for example, a box with a lid that automatically opens to allow the arm to extend and closes when the arm is stowed. Alternatively, any suitable cover may be used to cover the stowed arm. In certain embodiments, the arm may remain exposed when in a stowed position.

The robotic arm may be factory mounted on the car or it may be purchased as a kit and mounted as an after-market installation. In either case, the arm is physically mounted to the vehicle at a base portion of the robotic arm. Any suitable mounting method may be used. In some embodiments, a base of the arm may be directly bolted or welded to the roof of the vehicle as an integral part of the vehicle body. In certain embodiments, the arm may be removable from a base portion. In some embodiments, the arm may have an elongated base portion that is mounted alongside a roof-rack. The elongated base may have, for example, a housing for an actuator on one end and a cradle for the stowed arm.

The arm is electrically coupled to the vehicle's electric system, including the vehicle's battery, to transfer power from the charger of the arm to the vehicle's battery. An electrical conductor extends from the arm's charger to its base. In some embodiments, the conductor passes internally through the arm, from the charger to the base. The conductor may pass through, for example, a conduit in the arm. In certain embodiments, the conductor is located external to the arm. For example, an electrically conductive wire may be attached to the charger and pass along the outside of the arm to the vehicle.

At the base of the arm, the conductor may be coupled to conductors, such as wires, in the vehicle. The conductors from the arm or the vehicle may pass through an opening in the body of the vehicle. In some embodiments, the conductor from the arm may connect to the vehicle's electrical system by plugging into or coupling with an electrical receptacle on the vehicle's body. Alternatively, any suitable method for electrically coupling the arm and the vehicle for transferring electrical power from the base of the arm to the vehicle's electrical system may be used, such as wireless power transfer.

A conductor, such as wires, may also couple the vehicle's battery to an actuator in the arm. In some embodiments, wires may couple a battery for powering the arm to the vehicle's electrical system. The battery for powering the arm may be located outside the vehicle, such as, for example, in or on the arm. For example, the battery may be located in a base portion of the arm. In some embodiments, the battery may be attached to the outside of the arm. In certain embodiments, the battery may be located within the vehicle and be electrically coupled to a conductor in the arm in a manner similar to those described above for coupling the charger of the arm to the vehicle.

In some embodiments, there may also be connectors for coupling wires for transferring data, such as fiber optic wires or copper wires, from the arm to data systems in the vehicle. The wires in the arm may transfer, for example, optical data from a camera in the arm or data from a processor or a readable memory to, for example, a display in the vehicle or a computer located in the vehicle. The data may also include digital scale readings for 3D mapping from an actuator being sent to a computer in the vehicle or in the arm. As with the electrical conductors discussed above, the wires for transferring data may be coupled to the vehicle's systems through an opening in the vehicle's body or by coupling the arm's data wires to a connector at a receptacle mounted on the vehicle. Alternatively, in certain embodiments, data from the arm may be wirelessly transferred to systems in the vehicle. Any suitable wireless technology may be used.

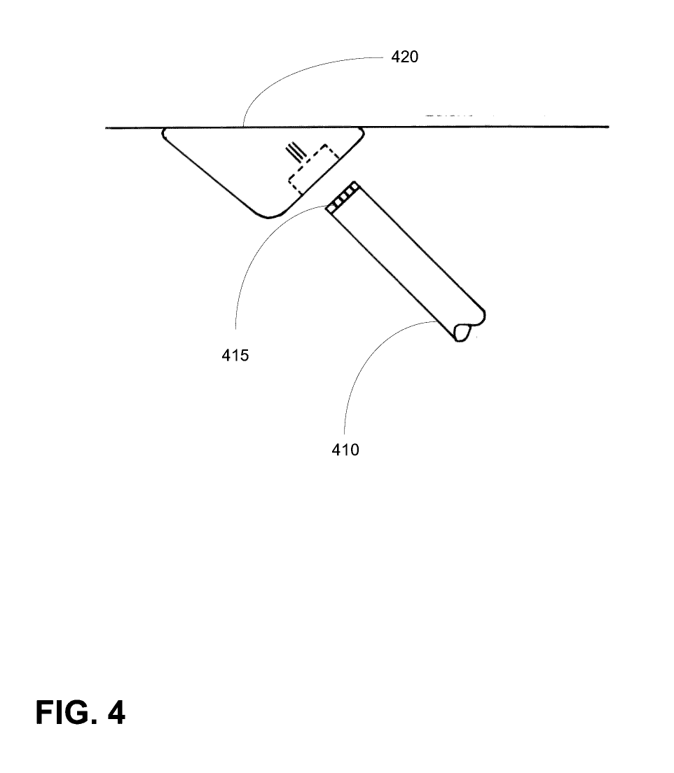

Referring to FIG. 4, charger 415 of arm 410 may be attached to the distal end of the arm 410. In some embodiments, the charger 415 may be rigidly affixed to the arm 410. In certain embodiments, the charger 415 may be connected to the arm 410 through a flexible joint or wrist. The flexible joint may allow rotational or translational freedom of movement with anywhere from one to six degrees of freedom. For example, the charger may spin around an axis running parallel to the arm and through the arm. In some embodiments, the charger may have rotational freedom around either of the mutually perpendicular lateral axes (lateral with respect to the flexible joint if the vertical axis is parallel to the length of the charger) with an origin at the flexible joint, allowing the charger to pivot. Movement of the charger at the flexible joint may allow fine movement of the charger for small adjustments to couple the charger with a charging port 420 of an EVSE.

In certain embodiments, the flexible joint between the charger and the upper portion of the arm may allow translational motion. For example, the charger may move laterally up or down (away from or towards the upper portion of the arm) in order to, for example, push the charger towards the charging port.

Movement of the charger, in embodiments where it is moveable relative to the upper portion of the arm, is provided one or more actuators. As described earlier for other members comprising the arm, the one or more actuators may be located at the joint or away from the joint. They may directly drive the charger, if they are located at the joint, or may be coupled to the charger through a drive mechanism.

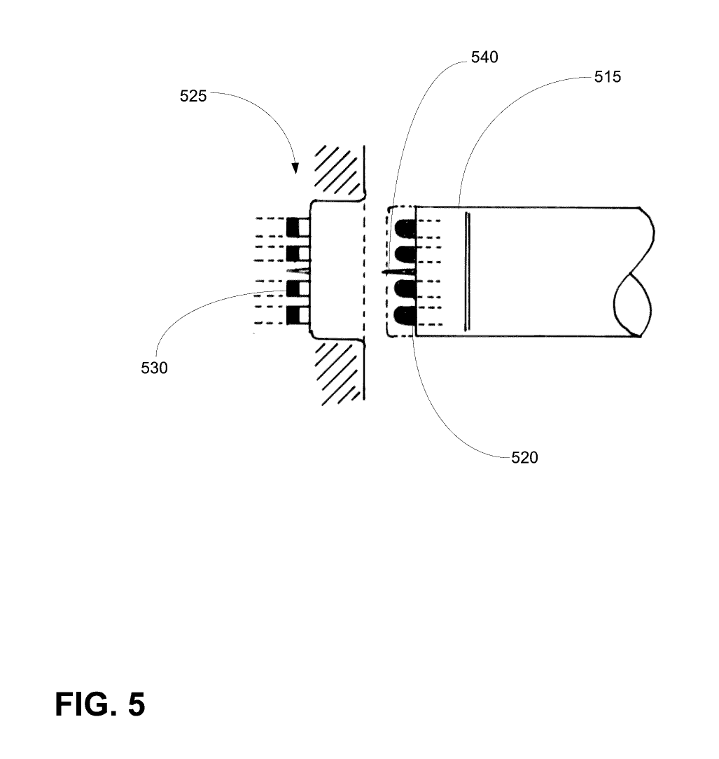

The charger may couple with an EVSE using any suitable coupling means. In some embodiments, the charger couples with the EVSE using connectors designed according to SAE J1772 standards for electrical connectors for electric vehicles. Referring to FIG. 5, charger 515 includes electrical contacts 520. In some embodiments, the electrical contacts 520 may be electrical probes or electrical pins. During vehicle charging, each probe or pin may be received in a socket of a charging port 525 of the EVSE, where the probe or pin contacts electrical contacts 530 of the charging port 525. In the embodiment shown in FIG. 5, the charger 515 has four electrical pins. In certain embodiments, any suitable number of electrical contacts may be used. In some embodiments, the charger may include sockets for mating with probes in the EVSE charging port.

Referring to FIG. 5, the electrical contacts 520 may be extendable probes. In this embodiment, the probes in the charger 515 may normally be concealed within recesses or silos. When the charger 515 couples with the charging port 525, the pin 540 is depressed, causing the probes to move out of their recesses and to make contact with the electrical contacts 530 of the charging port 525. Charging may commence once the charger 515 is coupled with the charging port 525. In some embodiments, a signal may be sent to the EVSE to commence charging once the charger and charging port are engaged. The signal may comply with SAE J1772 protocols.

In some embodiments, the electrical contacts may include conducting strips or plates that physically contact corresponding EVSE conducting strips or plates. Alternatively, in some embodiments, other suitable methods of power transfer may be used, such as wireless power transfer. Where wireless power transfer is used, power transfer between the arm and the charging port occurs without physical contact between electrical conductor in the arm and the charging port. In these embodiments, there may be no electrical contacts. Instead, the charger and the charging port electrically couple through induction. For the purposes of this document, electrical coupling includes inductive coupling.

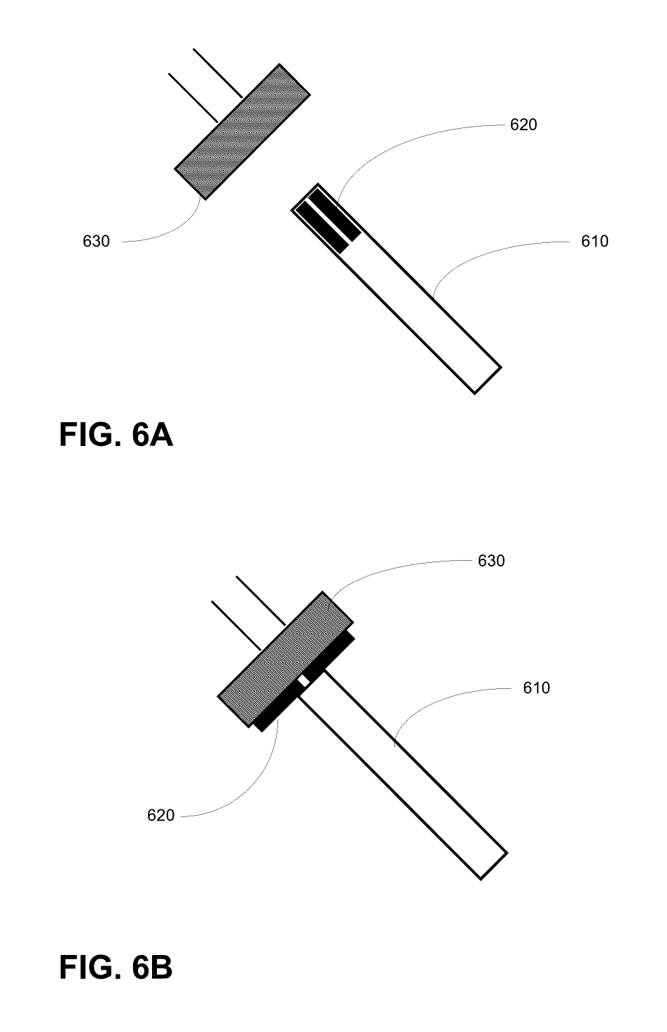

Referring to FIG. 6A, a charger 610 with recessed induction probes 620 is shown approaching a charging port 630. The induction probes 620 have electrical coils inside them electrically coupled to the vehicle's electrical system. The probes 620 themselves may be non-conducting. For example, the surface of the probes 620 may be made of a polymer material, a composite material, such as fibreglass, or a ceramic material. Referring to FIG. 6B, the probes 620 are extended from the charger 610 and are in contact with the charging port 630. The charging port 630 has inductors (coils) under the surface to couple with the coils in the probes 620 and wirelessly transfer power to the charger 610. The surface of the charging port 630 may be formed of non-conducting materials. Although the charging port 630 and induction probes 620 may be in physical contact during charging, the electrically charged components of the charging port 630 do not physically contact the electrically charged components of the induction probes 620 during charging.

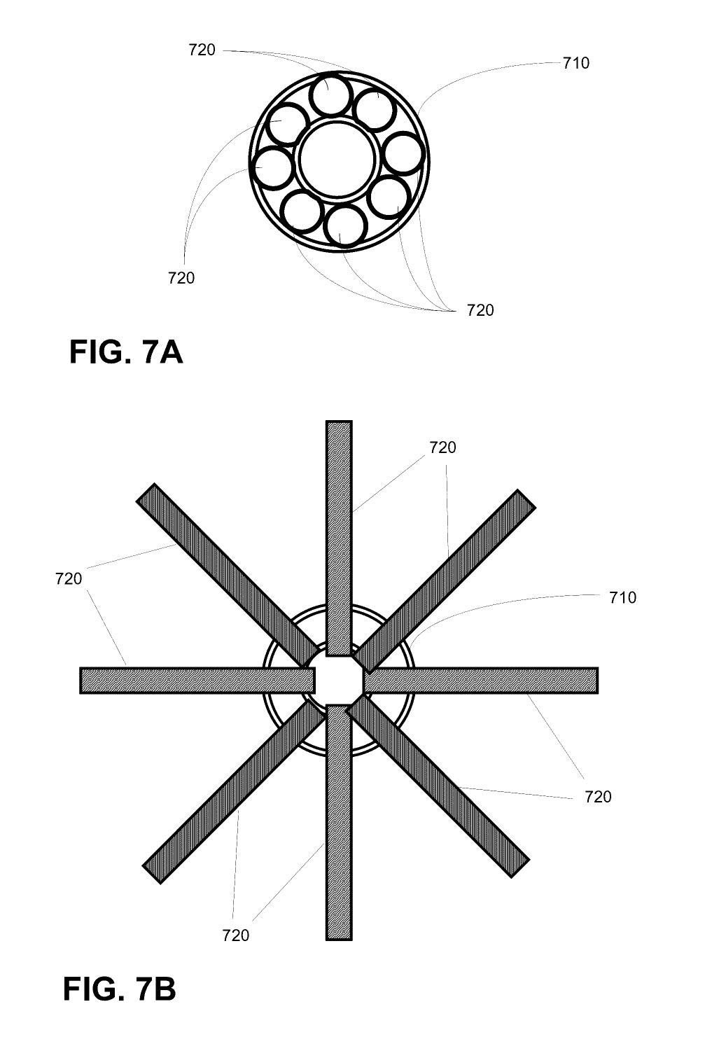

Referring to FIG. 7A, another configuration of a charger 710 containing recessed induction probes 720 is shown. Adding additional probes may increase the rate of power transfer. FIG. 7B shows the induction probes 720 fully extended. The induction probes 720 may contact a charging port with electrical coils inside to couple with the coils inside the induction probes 720 for wireless power transfer. As with the probes shown in FIGS. 6A and 6B, the induction probes 720 may have non-conducting exteriors.

The induction probes shown in FIGS. 6A, 6B, 7A, and 7B physically contact the charging port. In certain embodiments, the induction probes may be spaced apart from the charging port during charging.

Referring again to FIG. 5, the charger 515 may be shaped to mate with a corresponding portion of the charging port 525. This allows the charger 515 to be positioned based on mating the charger 515 with the receptacle in the charging port 525 rather than based on an individual electrical contact. The receptacle in the charging port acts to guide the charger in its final coupling stage.

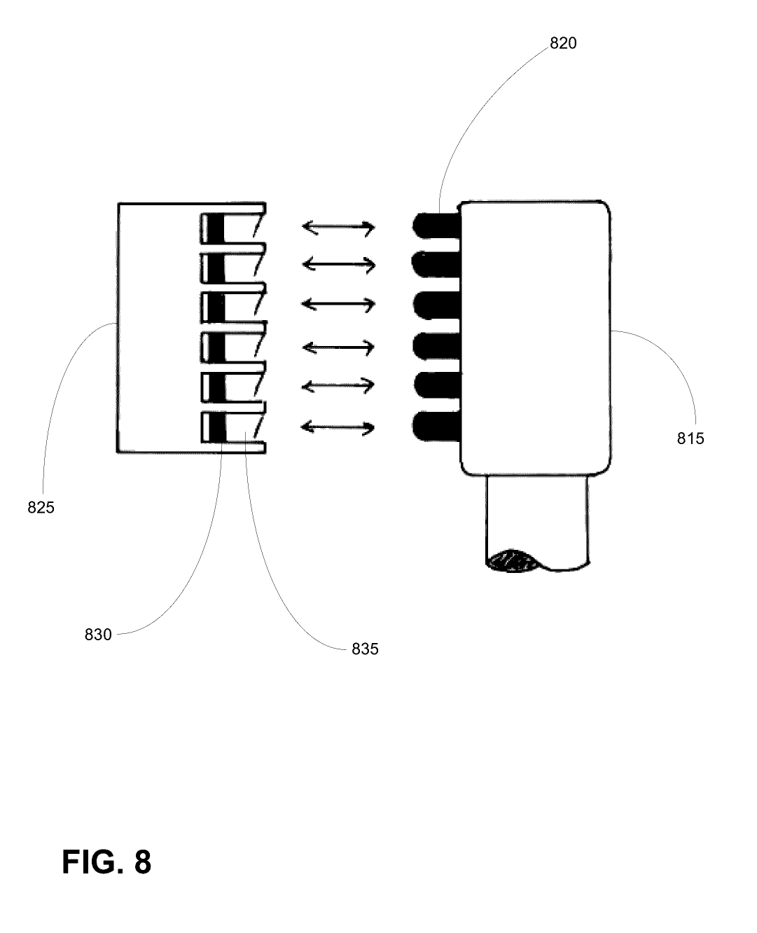

In some embodiments, the charger may not have any specific shape for mating with the charging port. In these embodiments, the electrical contacts on the charger are aligned with the electrical contacts of the EVSE when the charger is being moved into position for coupling with the EVSE. For example, referring to FIG. 8, charger 815 includes several electrical probes 820. In this embodiment, the probes are positioned on a side of the charger 815 rather than at the end. During charging, the probes 820 make contact with electrical contacts 830 contained in sockets 835 in a charging port 825 of the EVSE. For charging, the probes 820 are aligned with the sockets 835 before being moved into the sockets 835. The charger 815 may also couple with an EVSE using electrical tracks with conductors running in the tracks.

The charger may be formed of any suitable material, including metals, polymers, ceramics, or composites. The portion of the charger adjacent to the electrical contacts of the charger and any portion that may contact the electrical contacts of the EVSE is composed of or coated with an insulating layer. Any suitable insulating material may be used. For example, the portion of the charger adjacent to the electrical contacts may be formed of polymers, ceramic materials, composites including carbon fiber based materials and fibreglass, or any other suitable material or combination of materials.

Referring again to FIG. 1, the charging system 100 includes a computer comprising a processor 135 communicatively coupled to a readable memory 140 and the actuator 120. In some embodiments, the computer is located within the arm 115 or on the arm 115. For example, it may be attached to a base portion of the arm 115. In certain embodiments, the computer is located within the vehicle 105. It may be communicatively coupled to the actuator 120 through physical wires, as described earlier, or using wireless means and a controller attached to the actuator 120. In the wireless case, the controller, which includes a wireless receiver and transmitter, receives instructions from the processor 135 and controls the actuator 120 accordingly.

The readable memory 140 has executable instructions stored on it for execution by the processor 135. The instructions include instructions that the processor 135 executes to control the actuator 120 to guide the charger 130 to electrically couple with the charging station 110.

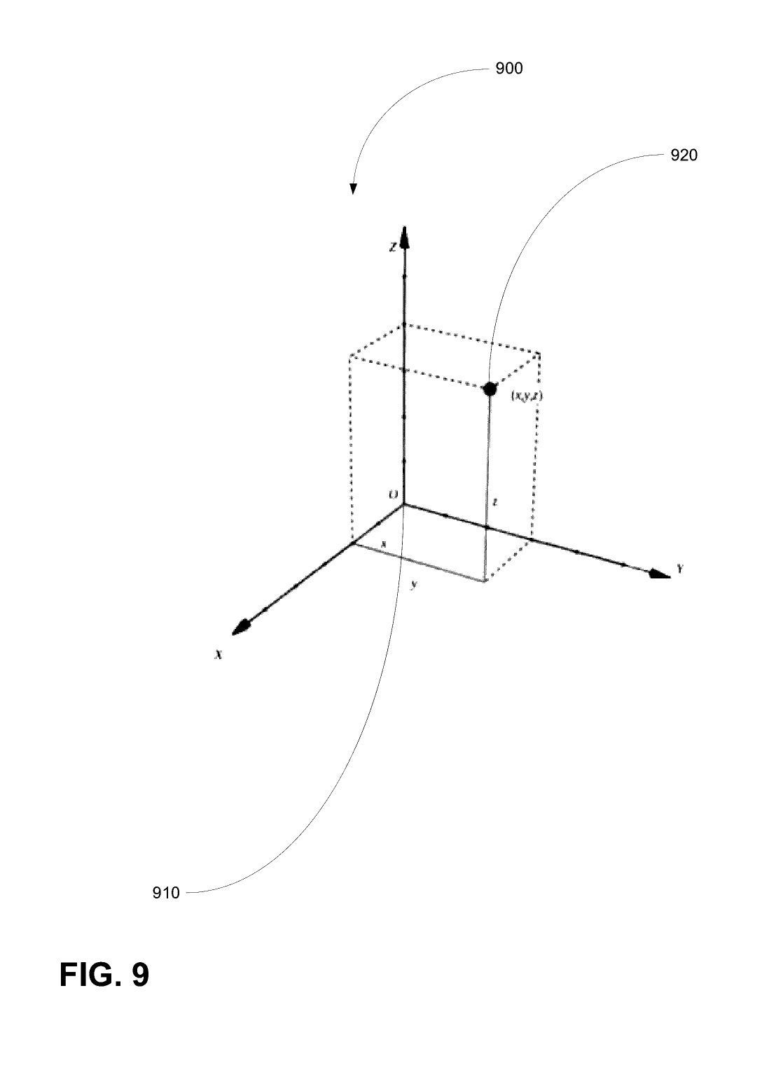

In some embodiments, the processor uses a virtual coordinates mapping method to guide the charger to couple with the charging station. Referring to FIG. 9, the coordinate system 900 used in virtual coordinates mapping for coupling the charger with a charging port of the charging station is shown. The zero position 910 is the stowed/parked position of the charger at rest. The charger positioning coordinates change with its movement towards the charging port. The coupling destination 920 is the predetermined position of the stationary charging port and is wirelessly communicated to the computer by the charging station. As the processor controls the arm using one or more actuators, the coordinates of the charging port are updated in real time to compensate for any variance. The processor stops moving the arm when the charger and the charging port have the same coordinates. In some embodiments, the standard SAE J1772 protocol for communication between electric vehicles and charging stations is observed.

In certain embodiments, a transmitter in the arm wirelessly transmits the charger's position to a receiver in the charging station. The charging station receives the wireless signals, decodes them and computes positioning data with reference to its own position. This positioning data is then transmitted by a transmitter in the charging station to a receiver in the arm. The arm's processor uses the received data to update its mapping coordinates and causes the actuator to move the arm such that the charger moves towards the destination coordinates of the charging port. The wireless signals between the arm and the charging station may be radio frequency signals. The communication between the arm and the charging station and the calculation of coordinates may occur in real time at high speeds.

Charging may commence once the charger is in position. In some embodiments, a locking mechanism may be used to lock the charger in position to reduce the possibility of the charger disengaging from the charging port. Any suitable locking mechanism may be used. The engagement of the locking system may result in a signal to the charging system to begin charging.

In some embodiments, commencing and ending charging may follow SAE J1772 protocols. In certain embodiments, the charger may include a pilot pin or a proximity switch, or both, to control charging. The pilot pin may be used in providing an indication of different states of charging, such as, for example, “not connected”, “connected ready mode”, “charging”, and “Error” amongst others. The proximity switch or pin may, in some embodiments, function as a safety feature to signal to the vehicle to stop drawing current. In certain embodiments, engagement of the pilot pin and/or the proximity switch may be needed before power may flow from the charging port to the charger. The command for charging may originate at the vehicle once the pilot pin and/or the proximity switch of the charger are engaged with the charging port. If the vehicle is in the process of charging and the charger is disconnected from the charging port, proximity detector, which may be a pin in some embodiments, breaks contact first causing a power relay in the charging station to open and cutting power to the charging port. In certain embodiments, the proximity detector may also be coupled to a disengage switch in the vehicle. If the user chooses to end charging before the vehicle's battery is fully charged, the proximity detector may disengage first, causing the charger to stop drawing current before the charger decouples from the charging port. In some embodiments, the disengage switch may also act as an activation switch for the arm and may be located, for example, in the vehicle, on a wireless fob, or on the arm itself.

When charging has reached a predetermined capacity, a signal is triggered for the arm to disengage and follow an automatic re-stow procedure. In some embodiments, a vehicle battery monitoring system may trigger a disengage signal once it detects that the battery is fully charged. The disengage signal may be received by the arm's processor, which then initiates a disengage process. In certain embodiments, the disengage signal may be directly communicated to the charging station by the vehicle battery monitoring system and the charging port may then communicate a disengage signal to the arm. Charging is then ended, the charger decouples from the charging port and the arm is stowed. In some embodiments, the processor reverses the instructions that were used for moving the charger to the charging port.

In some embodiments, a built-in safety mechanism is included to stop the arm from moving if the movement is interrupted by a soft resistance with any object other than the charging port or stow bay. A press on an activation button may resume the movement or reset the arm to a stow position.

In some embodiments, the arm may be activated using an activation button. The activation button may be located in the vehicle. It may be coupled to the processor through a wired connection. In some embodiments, the activation button may be communicatively coupled to the processor wirelessly. In certain embodiments, the activation button may be located on a wireless fob. An activation button may also be located on the arm itself.

In certain embodiments, the user may be able to remotely activate the charging procedure using, for example, the internet. For example, after parking the vehicle, the user may leave the vehicle and later decide to activate charging. The user may login in to a website and activate charging.

In some embodiments, arm deployment and charging may automatically begin if the vehicle is parked within range of an EVSE, without the user having to actively start the charging process by pressing a button. For example, if the car is parked within range of a charging port of an EVSE and turned off, a processor in the vehicle or the arm may determine that the vehicle should be charged if the battery's charge level is below a predetermined threshold. The arm's processor may then initiate charging by communicating with the EVSE and deploying the arm.

In use, according to some embodiments, the user initiates the charging process by pressing an activation button on the car dashboard, or a remote fob to activate the arm. The processor performs a preparatory sequence to communicate with the charging port by wireless radio signal to determine wireless linkage and maneuverable parameters. When the protocol is affirmed, the processor uses the coupling coordinates, with real-time compensation, to cause the actuator to move the arm to couple the charger to the overhead charging port. The processor and the charging station communicate in real-time to synchronize data coordinates (mapping) to move the arm to couple with the charging port. Once charging is complete, the processor executes instructions to move the arm back to a stowed position.

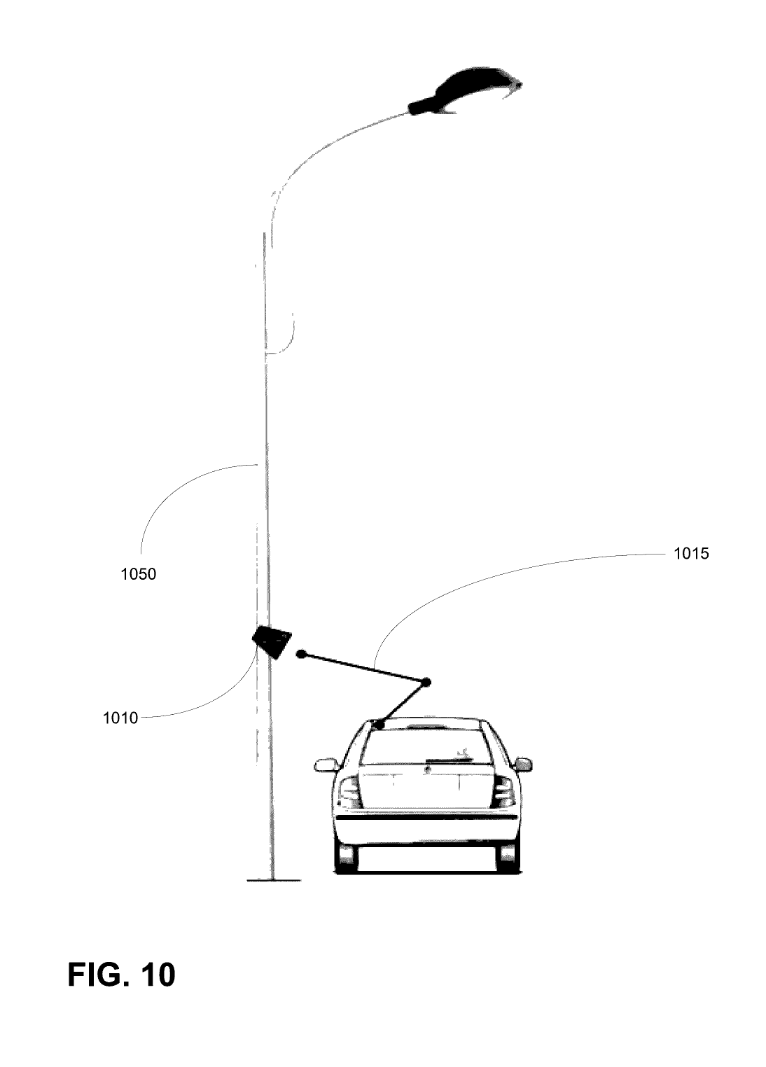

Referring to FIG. 10, in some embodiments, the user may automatically pay for charging a vehicle using a paid charging EVSE 1010. When the arm 1015 is coupled with the paid charging EVSE 1010, the wireless connection between the vehicle and the EVSE 1010 may be used to send the user's account (set up in the vehicle) to the EVSE 1010. The EVSE 1010 may wirelessly charge the user's web-based subscription account for the electrical usage. Accounts may have preauthorized payment by credit card.

As shown in FIG. 10, the EVSE 1010 may be attached to various electrical sources, such as a lamp post 1050. The ability for overhead charging using the arm 1015 provides the user with convenient access to the EVSE 1010.

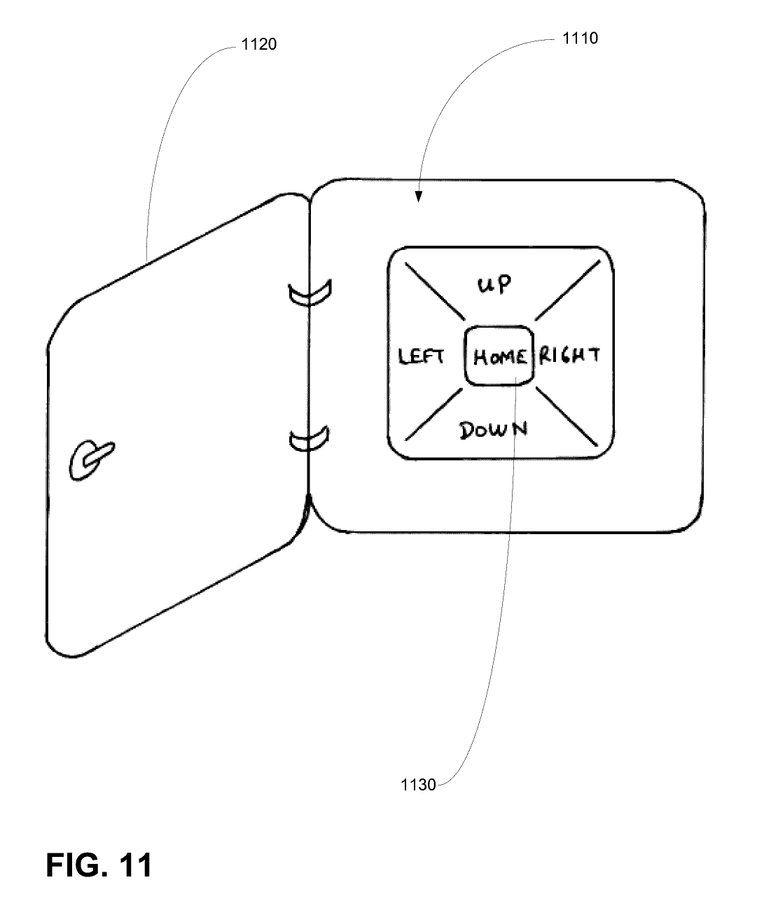

Referring to FIG. 11, the charging system may include a backup mode to control the arm in the event of a malfunction, such as a failure to fully couple. A keypad joystick 1110, which may be located, for example, on the vehicle body panel, the base of the arm, the key fob, or inside the vehicle, may be used to manually control movement of the arm to couple with the charging port of an EVSE. In some embodiments, the keypad joystick 1110 may be accessible by lifting a flap 1120. A “home” button 1130 may be used to automatically return the arm to its stowage position.

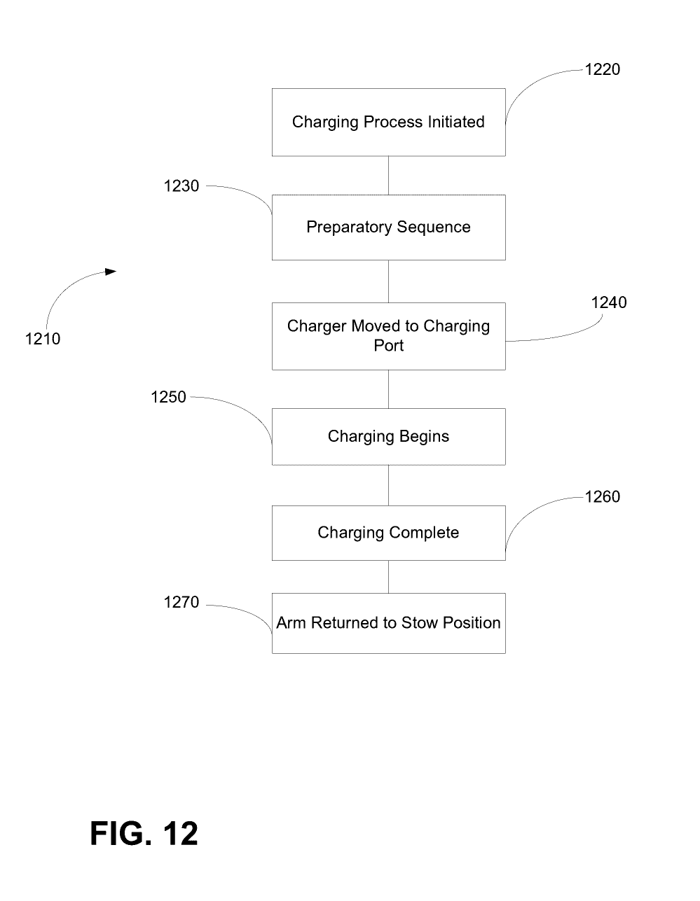

Referring to FIG. 12, an embodiment of a method for electrically coupling an electric or hybrid vehicle to a charging station is shown at 1210. At box 1220, the charging process is initiated by the driver pressing an activation button. A signal is sent to the processor to begin the charging process. At box 1230, the processor performs a preparatory sequence to communicate with the charging port by wireless radio signal to determine wireless linkage and maneuverable parameters. At box 1240, the processor causes the actuator to move the arm to couple the charger to the overhead charging port. At box 1250, charging begins. At box 1260, a signal is triggered for the arm to disengage due to the vehicle's battery reaching a predetermined charge capacity. At box 1270, the processor causes the arm to return to a stowed position.

In some embodiments, a method for electrically coupling an electric or hybrid vehicle to a charging station includes actuating an arm mounted on the vehicle, wherein the arm includes a charger electrically couplable to the vehicle's electrical system and where the arm is coupled to an actuator, and guiding the charger to electrically couple with the charging station.

### Alternatives

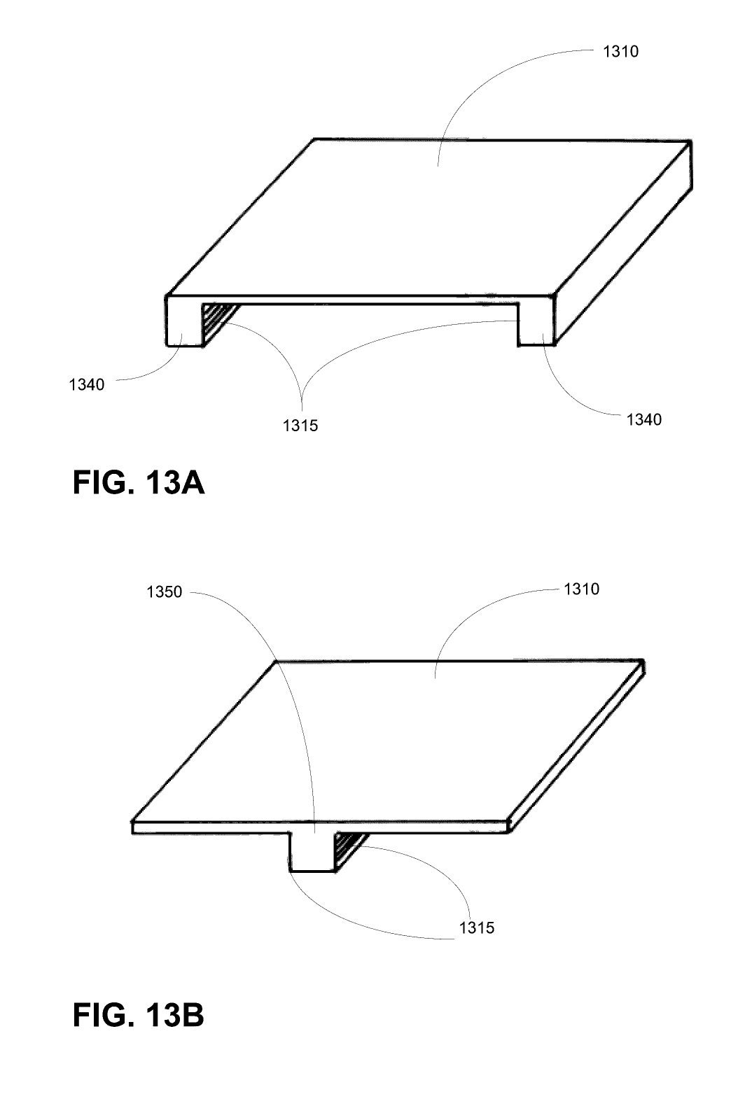

Referring to FIG. 13A, some EVSEs may use an overhead charging board 1310 with a track 1315 running along the board containing electrical contacts. The electrical contacts may run in grooves along the length of the track 1315. In some embodiments, the track 1315 may run along the sides of the board 1310. For example, ridges 1340 may extend down from the sides of the board 1310 with a conducting track 1315 running along the ridges 1340. Referring to FIG. 13B, the charging board 1310 may have a track 1315 running along the board 1310 away from the sides. For example, a ridge portion 1350 may extend down from the board 1310 with conducting tracks 1315 running on one or both sides of the ridge 1350. To electrically couple with the track 1315, the arm may be moved vertically up and then laterally in one direction to align the charger with the track 1315. The charger may have a configuration such as that shown in FIG. 8, with the electrodes on one side of the charger in order to engage with the tracks 1315.

In use, in accordance with some embodiments, the user initiates the charging process by pressing an activation button. The processor causes the arm to move vertically upwards until the charger makes physical contact anywhere along the charging board. The processor then causes the arm to move horizontally, swinging a predetermined distance either left or right to make electrical contact with the conducting tracks 1315 in the charging board 1310. When charging has reached a predetermined capacity, a signal is triggered for the arm to disengage. The processor then causes the arm to return to a stowed position. In certain embodiments, the arm may swing laterally left or right until it makes physical contact with the track 1315 rather than moving a predetermined distance. In some embodiments, the standard SAE J1772 protocol for communication between the EVSE and vehicle is observed.

In some embodiments, electrical power may be wirelessly transferred between the charging board and the charger using inductors. In these embodiments, the processor may cause the arm to move vertically upwards until it is sufficiently close to the board for electrical coupling through induction (inductive coupling), at which point power transfer may begin.

In some embodiments, an overhead charging port for coupling a charging station to an electric vehicle includes a panel with a planar surface. The planar surface has a ridge extending from it. An electrical conductor is attached to a surface of the ridge and is configured to couple with a charger from the electric vehicle. The electrical conductor is electrically coupled to the charging station. The panel has an attachment apparatus attached to it for suspending the panel above a driving surface. The attachment apparatus may include any suitable apparatus for coupling the panel to a structure that the panel is to be suspended from. For example, the attachment apparatus might include rings or bosses or slots for attaching cables. The cables may be attached to a pole, a wall, a ceiling, or other structure for hanging the panel from. The attachment apparatus might include, for example, cables, chains, or ropes fixed to the panel. The cables, chains, or ropes may be attachable to a structure that the panel is to be suspended from. In some embodiments, the attachment apparatus might include a bracket for bolting to a beam extending from a structure that the panel is to be suspended from. In certain embodiments, the attachment apparatus may be a beam that may be bolted or otherwise attached to a wall or a pole or other structure suitable for suspending the panel from.

In some embodiments, a secondary guidance method is used to maneuver the charger to the charging port using a camera. The camera is attached to the arm and communicatively coupled to the processor for optically guiding the charger to couple with the charging port. In some embodiments, the camera sends optical data to the processor so that the processor may optically guide the charger when the charger is within a predetermined distance of the charging port. In some embodiments, the processor may use, for example, optical pattern recognition techniques to align the charger with the charging port.

The camera may also be used to provide aerial views of the road. In some embodiments, the user may deploy the arm to rise above the car to provide a view around the car. In certain embodiments, the charger with the camera may be rotated to capture a panoramic view around the car. For example, the user may be able to determine causes of traffic jams by having an aerial view of the road. The arm may be manually controlled by the user through a manual control system in the car when using the camera. For example, the user may use any suitable control system, such as, but not limited to, a joystick, a touch screen, or a motion detection system. In certain embodiments, deployment of the arm for capturing images may be restricted to above the vehicle. In these embodiments, side deployment may be disabled for safety reasons. In some embodiments, the arm may be deployed for capturing images with the camera while the car is on or being driven.

The camera may include lenses on more than one side for capturing images in multiple directions. For example, the camera may have a lens on the front and another lens on the back. Images from the camera may be viewed on a screen in the vehicle. In some embodiments, the charger may also include a beacon for use as an elevated emergency beacon.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A charging system for coupling a chargeable battery in an electric vehicle with a charging station, the system comprising:
(a) an arm mountable on the vehicle;
(b) an actuator coupled to the arm and configured to move the arm;
(c) a charger coupled to the arm and electrically couplable to the vehicle's electrical system;
(d) a processor communicatively coupled to the actuator and configured to control the actuator;
(e) a readable memory communicatively coupled to the processor and having stored thereon instructions executable by the processor for controlling the actuator to move the charger to electrically couple with the charging station.

2. The system of claim 1 wherein the arm comprises multiple members connected in series by flexible joints.

3. The system of claim 1 wherein the arm is mountable to the top of the electric vehicle.

4. The system of claim 1 wherein the instructions further comprise instructions for using coordinate mapping to guide the charger to couple with the charging station.

5. The system of claim 1 further comprising a wireless communications port communicatively coupled to the processor for wirelessly communicating with the charging station.

6. The system of claim 1 wherein the charger is raisable by the arm for engaging with an overhead charging board of the charging station.

7. The system of claim 1 further comprising a camera attached to the arm and communicatively coupled to the processor for optically guiding the charger to couple with the charging station.

8. The system of claim 1 wherein the instructions further comprise instructions for uncoupling the charger from the charging station and returning it to the vehicle upon receipt of a cease charging signal.

9. The system of claim 1 further comprising a manual control hub communicatively coupled to the processor for inputting commands to move the arm.

10. The system of claim 1 further comprising instructions stored on the readable memory for execution by the processor for wirelessly sending payment information to the charging station to pay for charging.

11. A system for charging an electric vehicle, the system comprising:
(a) an overhead charging board comprising conductors, wherein the overhead charging board is couplable to a charging station;
(b) an arm mountable on the vehicle;
(c) an actuator coupled to the arm and configured to move the arm;
(d) a charger coupled to the arm and electrically couplable to the vehicle's electrical system;
(e) a processor communicatively coupled to the actuator and configured to control the actuator;
(f) a readable memory communicatively coupled to the processor and having stored thereon instructions executable by the processor for controlling the actuator to move the charger to electrically couple with the overhead charging board.

12. A method for electrically coupling an electric or hybrid vehicle to a charging station, the method comprising:
actuating an arm mounted on the vehicle, wherein the arm comprises a charger electrically coupled to the vehicle's electrical system and wherein the arm is coupled to an actuator, and guiding the charger to electrically couple with the charging station.

13. The method of claim 12 wherein coordinate mapping is used to guide the charger to couple with the charging station.

14. The method of claim 12 further comprising synchronizing mapping coordinates between the arm and the charging station.

15. The method of claim 12 further comprising wirelessly communicating with the charging station using a wireless communications port.

16. The method of claim 12 wherein guiding the charger comprises raising the charger with the arm to engage the charger with an overhead charging board of the charging station.

17. The method of claim 12 further comprising optically guiding the charger to couple with the charging station using a camera attached to the arm.

18. The method of claim 12 further comprising uncoupling the charger from the charging station and returning it to the vehicle upon receipt of a cease charging signal.

19. The method of claim 12 wherein the arm is guided using commands manually input into a manual control hub to control the actuator.

20. The method of claim 12 further comprising wirelessly sending electronic data comprising payment information to the charging station to pay for charging.
